(19) United States
(12) Patent Application Publication
(10) Pub. No.: US 2020/0231003 A1
(43) Pub. Date: Jul. 23, 2020

(54) LEVELLING APPARATUS HAVING ECCENTRIC AND CENTRIC WHEELS

(71) Applicant: Leonard L. Hierath, Denver, CO (US)

(72) Inventor: Leonard L. Hierath, Denver, CO (US)

(21) Appl. No.: 16/664,293

(22) Filed: Oct. 25, 2019

Related U.S. Application Data
(63) Continuation-in-part of application No. 16/250,658, filed on Jan. 17, 2019, now abandoned.

(51) Int. Cl. B60B 33/04; B60B 33/00

(52) U.S. Cl. CPC B60B 33/04; B60B 33/0042

(57) ABSTRACT

A method and apparatus for levelling a transport carrier having eccentrically and centrically mounted wheels on a housing. The wheel/housing apparatus is adapted to reach mechanical equilibrium with rotation on a surface.

### FIELD

The present device relates to a form of multi-wheel housing and more particularly to a method and device for levelling a carrier using a housing with eccentric and centric wheels.

### BACKGROUND

Rolling wheel mounts for tables and the like generally comprise at least one wheel in combination with an axle, and a caster wheel fork. Conventional wheel mounts usually roll in one vertical plane providing steerability but may also rotate 360°. In the simplest form, the wheel rotates about an axle that is secured to a fork or frame. When tables or transport carriers and portable equipment are used in conjunction with rolling wheel mounts, often there is a difficulty in stabilizing and levelling the movable object. For example, tables having rotatable casters at the base and serving tables with levelling screws are often moved and become off-balance due to changes in the surface upon which the wheels are resting. Typically, in order to level or stabilize the table, a user must alter the leveling screws at the base of the platform to adjust and achieve stability. This type of adjustment is cumbersome, time consuming and often, not practical to perform. Another option is to place a levelling device under the wheels for a temporary adjustment. Even when a table is stable with properly adjusted leveling screws or a levelling device, the situation changes when the table is moved to a new location to setup for a larger size dining party. The ideal levelling device will allow the user to quickly adjust the carrier stability without leaning down toward the floor. The current apparatus and method allow the user to level and stabilize the transport carrier quickly. The user simply grips the transport carrier and pushes the transport carrier back and forth, preferably once but it may require an additional pass about four inches along the same path, generally in a linear, horizontal direction. This allows the wheels to roll and re-calibrate to compensate for the uneven floor resulting in a level table.

### SUMMARY

The present embodiment is preferably comprised of a multi-wheel leveler with a stabilization housing having an axially extending axle aperture passing therethrough and an upper vertically extending socket or stem member positioned directly above the aperture, at least one axle member mounted within the axle aperture, a bolt member mounted within the socket, at least one flexible wheel or disc rotatably mounted on the axle member and having an eccentric axle entry point and at least one rigid wheel or disc rotatably mounted on the axle member in spaced relation to the eccentrically mounted wheel and having a centric axle entry point. Each of the wheels are rotatably mounted in spaced relation to each other and the housing, are mounted on the housing with at least one axle member, and are adapted to provide a surface contact point on a surface. The wheels have a treaded surface and are mounted in equi-distant relationship between each of the wheels. The axle member includes a pin member mounted on a terminal end of the axle member. The stabilization housing extends vertically from the first and second axle member.

There is also provided a method of levelling a multi-legged support member with a multi-wheel assembly, the steps comprising mounting an eccentrically engaged first flexible wheel on a housing, mounting a centrically engaged second rigid wheel on the housing in spaced relation to the first wheel, threadedly engaging the multi-legged support member to the housing with a housing bolt member, urging the housing and the multi-legged support member in a linear, horizontal direction, balancing the centrically mounted wheel on a flat surface, and rotating the eccentrically and centrically mounted wheels in a linear direction. The steps further include driving the housing and the wheels in a forward and reverse direction on a surface, equilibrating each of the wheels on the surface.

### BRIEF DESCRIPTION OF THE DRAWINGS

The present forms may be better understood, along with its numerous objects, features, and advantages made apparent to those skilled in the art by referencing the accompanying drawings.

FIG. 1 illustrates a perspective view of a double wheel assembly;

FIG. 2 is an exploded view of FIG. 1;

FIG. 3 is a front view of FIG. 1;

FIG. 4 is a top plan view of FIG. 1;

FIG. 5 is a side view of FIG. 1;

FIG. 6 is a cross-sectional view of FIG. 3 about lines 6-6;

FIG. 7 is an opposite side view of FIG. 5;

FIG. 8 is a bottom plan view of FIG. 1;

FIG. 9 is a view of the assembly on an elevated surface;

FIG. 10 is a view of the assembly on a depressed surface; and

FIG. 11 is view of the assembly.

### DETAILED DESCRIPTION

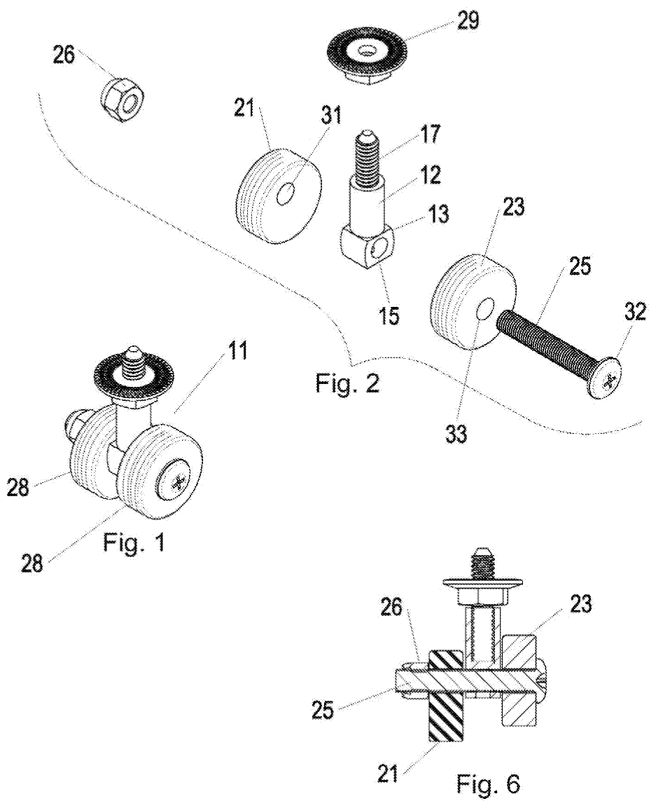

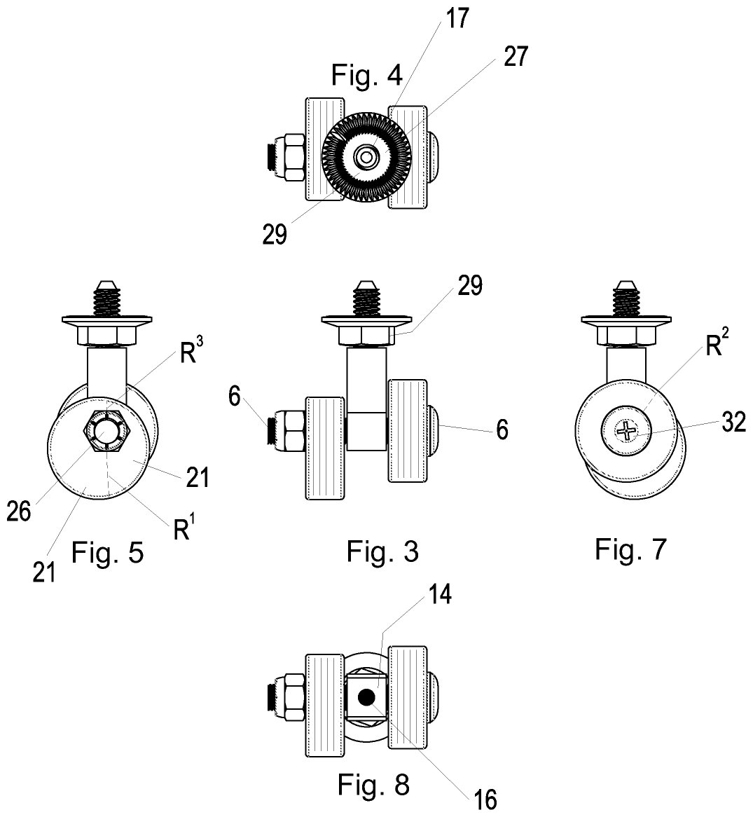

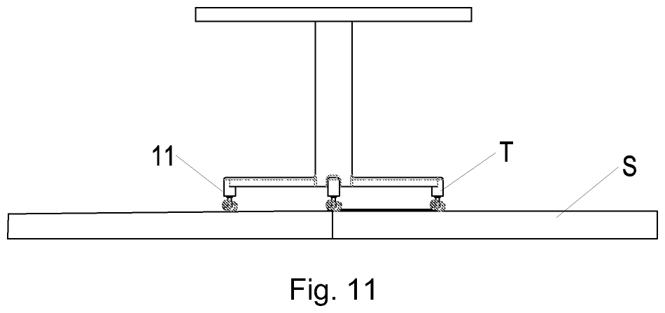

The current apparatus and method for levelling and stabilizing carriers or transport carriers such as a table is described and shown in FIGS. 1-11. There is provided a levelling assembly 11 broadly comprising at least four levelling members adapted to be mounted on corresponding legs of a table. Each levelling member having a stabilizing housing member 13 having at least one radially extending axle receiving member 15 passing therethrough, an upwardly extending threaded bolt member 17, dual wheels or discs 21 and 23 and axle member 25 with nut 26. The housing member 13 is of a semi-T-shaped configuration and is preferably made of rigid plastic or steel. The housing member 13 has a lower semi-rectangular configuration with a bottom portion 14 having recession 16 although other configurations are also included without departing from the scope. The axle receiving member 15 is preferably axially extending and situated along a mid-portion of the housing member 13 as shown in FIG. 2 and FIG. 6 but may be located along a lower or upper portion of the housing member with the opening preferably passing completely through the housing. It is contemplated that the axle receiving member could also comprise dual radially extending openings that are not in touching relation to one another. The axle receiving member 15 has a diametrically opposed and axially extending opening for accommodation of the axle member 25 and may also partially pass through the housing on opposites sides as described above.

At least two discs or wheels 21, 23 are vertically and rotatably mounted to the housing member 13 within the axle receiving member 15 to rotate about axle member 25 along a horizontal axis. Preferably, discs 21 and 23 are rotatably mounted in non-touching relation to one another with the housing member 13 located therebetween to permit rotation in side by side spaced alignment.

The eccentric wheel or disc 21 is made up of a flexible plastic material such as Ninjaflex made by Ninjatek or any urethane type of material but other flexible plastic materials may be used without departing from the scope. The wheel 21 is of a unitary, molded construction and the flexible plastic creates a strong but flexible wheel. The centric wheel 23 is made up of a rigid plastic material such as PolyLIte PLA manufactured by Polymaker and is also of a unitary, molded construction. The rigid plastic, such as polyactic acid of centric wheel 23 allows for a stable, weight-bearing durable base on flat surfaces. The disc 21 has an eccentrically aligned aperture 31 as best shown in FIG. 5. As the disc 21 rotates, the radial distance from the eccentric opening or aperture 31 to the surface or floor will increase or decrease as shown in FIG. 5 at R¹ and R³. When weight is placed on the housing with the dual wheels, the eccentric wheel 21 experiences a torque arm (force x distance) pushing the housing away from the floor. The centric wheel 23 balances the torque force, holding the housing in position. The radius of disc 21 will vary based upon the eccentric location of the axle. The eccentrically aligned aperture of disc 21 passes completely through disc 21 and is designed to accommodate the axle 25. The axle 25 is preferably of metal or rigid plastic with a pin or bolt member 26 at a terminal end and a bolt head 32 at the opposite end.

The centrically mounted wheel or disc 23 is located along an opposite side of the housing member 13 from the disc 21. The disc or wheel 23 is preferably made up of a rigid plastic having a diameter of at least 1¼ inches. The disc 23 has a centrically aligned aperture 33 passing through the disc 23 as best shown in FIG. 7. The radius of the disc 23, as shown in FIG. 7 at R² is relatively consistent along the entire circumference of the disc 23. The aperture 33 is designed to accommodate axle member 25 which then is inserted into axle receiving member 15, providing free rotation of the disc 23. The bolt head member 32 is located along one end of the axle member 25 in order to retain the axle in place. The axle 25 may be a single axle or comprised of a dual part axle and may be a telescoping member or have a length that may be accommodated by the housing member 13 if there are dual openings in the housing as described above.

The wheel 21 and wheel 23 are rotatably mounted on the axle 25, creating a static imbalance which occurs when the center of gravity of a rotating body does not coincide with the axis of rotation. The axle 25 is of a length sufficient to pass through the aperture of disc 21 and into the axle receiving member 15 of the housing member 13 and through the aperture of disc 23. The combination of the axle 25, eccentric and centric apertures and the axle receiving member 15 allows for free rotation of the disc 21 about the axle 25. Each wheel 21, 23 has a scored exterior surface or tread 28, creating a higher coefficient of friction with the floor to provide an enhanced gripping surface. The tacky nature of the plastic also contributes to the increased coefficient of friction.

The upper or top portion 27 of the housing member preferably is designed to accommodate the bolt member 17. The upper portion 27 is vertically aligned directly above the axle aperture 15 and the axle member 25 to provide a ballast or balance for the centric and eccentric wheels. The bolt member 17 is snugly positioned within the housing by threaded engagement within a socket. The bolt member 17 may then be fitted within the bore of a support leg by threaded engagement therewith. The bolt member 17 is preferably threaded stainless steel with a tightening member 29. The housing member 13 should have a sufficient circumference to accommodate at least one axle member and provide sufficient separation of the two discs 21 and 23 to allow for free rotation of both discs. Optimally there should be at least 0.05 inches of total end clearance between each of the discs 21 and 23 and the housing 13 and preferably the discs 21 and 23 are mounted equi-distant from the housing 13.

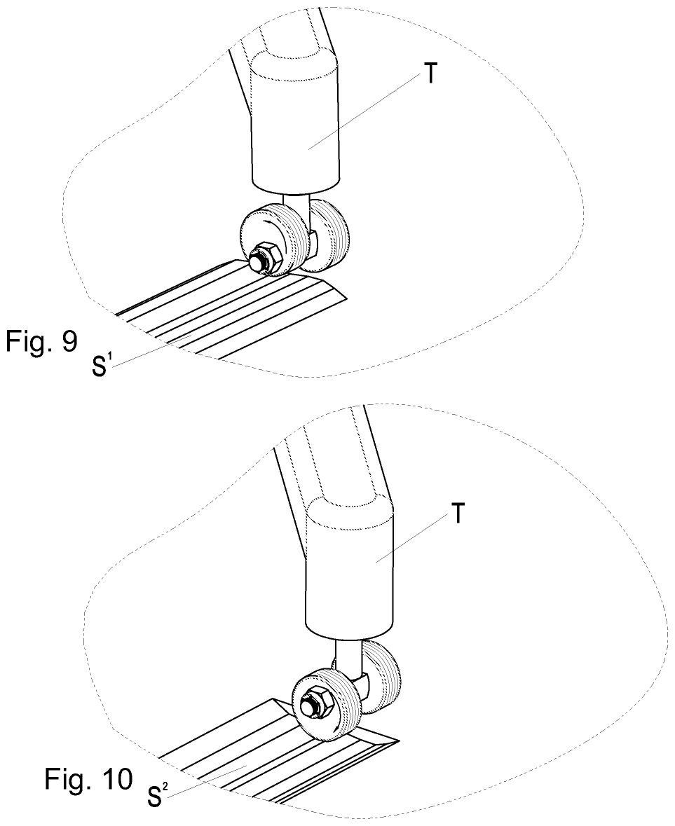

In use, the bolt member 17 is preferably threaded into a support member such as the leg of a table or transport carrier, providing a system where the multiple legs of a table have the assembly at the terminal ends of the table legs T as shown in FIGS. 9, 10 and 11. The system is preferably designed for use with transport devices or a support member such as a table and provides a quick and easy means for stabilizing and levelling of a table. The method involves mounting at least four multi-wheel assemblies, as described above, on to a multi-legged support member. As can be seen in FIGS. 9 and 10, the combination of the eccentric disc 21 and the centric disc 23 allow for adjustment of the assembly when the surface S changes. This can happen when tables are moved frequently, such as in restaurants. The equilibration occurs as the mechanical system (carrier, housing and centric and eccentric rollers) naturally seek a mechanical equilibrium. This is achieved when the net force on the disc or wheel is zero. When an offset S¹, S² (a bump or recess) causes table rocking, the carrier is generally being supported on only two diagonally located points.

The current apparatus utilizes an eccentric roller that rotates as the carrier is urged in a linear, horizontal direction. Preferably, the apparatus consisting of the dual wheels (eccentric and centric mounted) which rotate as the carrier is pushed forward and backward once or twice in a linear direction. Due to gravitational forces, the eccentrically and centrically mounted wheels seek equilibrium. In general, a non-level surface will result in compensation by the eccentrically mounted wheel as shown in FIGS. 5, 7, 9 and 10. As the eccentric disc rotates, the leg T is lifted to a higher height or forced upwardly causing the opposing leg T to move downward toward the surface or floor, until stability is achieved. In use, each of the first and second discs 21 and 23 are adapted to provide a surface contact point on a surface.

As a result, the eccentrically mounted wheels or discs reach equilibrium and the combination of wheels provide a ‘locked-in’ or ‘dug-in’ effect. Further, the scored exterior surface 28 of both wheels, 21 and 23, provides an enhanced gripping surface through use of a treaded wheel or disc. Since the wheels move in a linear direction, attempts to move the carrier or table to the left or right are resisted but urging the table forward and backward results in the levelling effect. The ‘dug-in’ effect can be easily reversed with a firm push on the table or carrier which results in a resetting of the equilibrium.

For example, on a level surface, all four wheels will generally rest on the centrically mounted wheels for equilibrium. If there is a portion of the surface that is depressed or raised, the wheel or disc with the eccentric mount will replace the centric wheel as the weight or support bearing wheel or disc. The effective support radius (or vertical height) of the eccentric disc is variable and as a result, the eccentric disc will be re-positioned through the forward and backward movement to reach equilibrium. In the case of a depression in a surface or floor, the eccentric disc will rotate and position for equilibrium with the increased radial side in a downward direction as shown in FIG. 10 and the positioning of the eccentric wheel will depend upon the level of depression. Conversely, if there is a raised surface, the eccentric disc will re-position so that the decreased radial portion of the disc will be the supporting wheel as shown in FIG. 9. Depressions or elevations on a surface results in a wheel shift to a greater or lesser radial portion.

When using at least four sets of double wheel systems, each wheel set will independently regulate or re-position based upon the contact surface. When moving the table, the apparatus with the dual wheels or discs will align so that the device seeks mechanical equilibrium which is dependent on the surface. In use, the apparatus may be threadedly engaged with a table support leg, preferably all four legs, and set up so the that wheels are engaged with a floor surface.

These quick adjusting levelling devices can also be used on transport tables and cabinets, replacing casters and leveling screws. These devices can be integrated in new table base designs or they can be used to replace leveling feet on table bases, which are now in restaurants or in restaurant supply houses.

While the present device and alternate forms have been described in connection with the illustrated embodiments, it will be appreciated and understood that modifications may be made without departing, from the true spirit and scope.

I claim:

1. A multi-wheel leveler comprising:
a stabilization housing having an axially extending axle aperture passing therethrough and an upper vertically extending socket positioned directly above said aperture;
at least one axle member mounted within said axle aperture;
a threaded bolt member threadedly engaged within said socket;
at least one flexible wheel rotatably mounted on said axle member and having an eccentric axle entry point; and
at least one rigid wheel rotatably mounted on said axle member in spaced relation to said eccentrically mounted wheel and having a centric axle entry point.

2. The leveler according to claim 1 wherein each of said wheels are rotatably mounted in spaced relation to each other and said housing.

3. The leveler according to claim 1 wherein each of said wheels are mounted on said housing with said at least one axle member.

4. The leveler according to claim 1 wherein each of said wheels have treaded surfaces.

5. The leveler according to claim 2 wherein said housing is mounted in equi-distant relationship between each of said wheels.

6. The leveler according to claim 1 wherein said at least one axle member includes a pin member mounted on a terminal end of said at least one axle member.

7. A levelling apparatus for a table having at least four legs, comprising;
at least four levelling members, each having a first flexible disc member mounted eccentrically on a first axle member;
a second rigid disc member mounted centrically on a second axle member;
a stabilizing member having a lower axial opening and an upper stem member positioned at said centric and eccentric mountings of said disc members;
said first axle member and said second axle member rotatably mounted within said at least one radial opening; and
a threaded bolt member threadedly engaged with said upper vertical aperture and said table leg.

8. The levelling apparatus according to claim 7 wherein said first disc member is mounted on a first side of said stabilizing member and said second disc member is mounted on an opposite, second side of said stabilizing member.

9. The levelling apparatus according to claim 7 wherein said first disc member comprises a flexible plastic.

10. The levelling apparatus according to claim 7 wherein said second disc member comprises a rigid plastic.

11. The leveling apparatus according to claim 7 wherein said first axle member and said second axle member are telescopically engaged with one another.

12. The levelling apparatus according to claim 7 wherein said centrically mounted disc is separated in space from said eccentrically mounted disc by said stabilizing member.

13. The levelling apparatus according to claim 7 wherein each of said first and second discs are adapted to provide a surface contact point on a surface.

14. The levelling apparatus according to claim 7 wherein said stabilizing member extends vertically from said first and second axle member.

15. A method of levelling a multi-legged support member with a multi-wheel assembly, the steps comprising;
mounting an eccentrically engaged first flexible wheel on a housing with an axle;
mounting a centrically engaged second rigid wheel on said housing with an axle, in spaced relation to said first wheel;
threadedly engaging said multi-legged support member to said housing with a housing bolt member;
threadedly engaging at least four of said multi-wheel assemblies with said multi-legged support member;
urging said housing and said multi-legged support member in a linear, horizontal direction;
balancing said centrically mounted wheel on a flat surface; and
rotating said eccentrically and centrically mounted wheels in a linear direction.

16. The method according to claim 15 wherein said housing bolt member is threadedly engaged with said housing member.

17. The method according to claim 15 wherein said steps further include driving said housing and said wheels in forward and reverse direction on a surface.

18. The method according to claim 17 wherein the steps further include equilibrating each of said wheels on said surface.

19. The method according to claim 15 wherein said housing is in direct contact with an axle receiving member.

20. The method according to claim 15 wherein said housing extends vertically from said axle.
